(19) United States
(12) Patent Application Publication
(10) Pub. No.: US 2014/0102072 A1
(43) Pub. Date: Apr. 17, 2014

(54) MULTI-SHAFT, MULTI-SPEED COMBINED CYCLE POWER SYSTEM

(71) Applicant: GENERAL ELECTRIC COMPANY, Schenectady, NY (US)

(72) Inventors: Michael John Bowman, Niskayuna, NY (US); Andrew Joseph Travaly, Ballston Spa, NY (US)

(73) Assignee: GENERAL ELECTRIC COMPANY, Schenectady, NY (US)

(21) Appl. No.: 13/651,915

(22) Filed: Oct. 15, 2012

(51) Int. Cl. F02C 6/00

(52) U.S. Cl. 60/39.182

(57) ABSTRACT

Various embodiments include power systems. In a particular embodiment, the power system includes a combined-cycle power system having: a first shaft having a first group of components coaxially mounted thereon, the first group of components including: a first steam turbomachine; a first gas turbomachine; and a reheat combustor; and a second shaft separated from the first shaft, the second shaft having a second group of components coaxially mounted thereon, the second group of components including: a second steam turbomachine; a second gas turbomachine; and a duct fluidly coupled to the second gas turbomachine and the reheat combustor, the duct for providing exhaust from the second gas turbomachine to the reheat combustor.

### FIELD OF THE INVENTION

The subject matter disclosed herein relates to power systems. More particularly, the subject matter relates to combined cycle power systems.

### BACKGROUND OF THE INVENTION

Conventional combined cycle (CC) power systems employ both a gas turbomachine (e.g., a gas turbine, GT) component and a steam turbomachine (e.g., a steam turbine, ST) component, coupled to one or more dynamoelectric machines (e.g., an electrical generator), to generate electrical energy. This electrical energy can be provided, e.g., to an electrical grid for powering commercial, residential, public and other applications.

The conventional turbines (e.g., GT and/or ST) are commonly configured to operate at a predetermined speed range, but some of the turbine hardware, e.g., including buckets (also referred to as blades) such as last stage buckets (LSBs) may operate more efficiently at different speeds outside of the predetermined speed range.

### BRIEF DESCRIPTION OF THE INVENTION

Various embodiments of the invention include power systems. In various particular embodiments, a combined-cycle power system is disclosed, the system including: a first shaft having a first group of components coaxially mounted thereon, the first group of components including: a first steam turbomachine; a first gas turbomachine; and a reheat combustor; and a second shaft separated from the first shaft, the second shaft having a second group of components coaxially mounted thereon, the second group of components including: a second steam turbomachine; a second gas turbomachine; and a duct fluidly coupled to the second gas turbomachine and the reheat combustor, the duct for providing exhaust from the second gas turbomachine to the reheat combustor.

A first aspect of the invention includes a combined-cycle power system is disclosed, the system including: a first shaft having a first group of components coaxially mounted thereon, the first group of components including: a first steam turbomachine; a first gas turbomachine; and a reheat combustor; and a second shaft separated from the first shaft, the second shaft having a second group of components coaxially mounted thereon, the second group of components including: a second steam turbomachine; a second gas turbomachine; and a duct fluidly coupled to the second gas turbomachine and the reheat combustor, the duct for providing exhaust from the second gas turbomachine to the reheat combustor.

A second aspect of the invention includes a system having: a first shaft having a first group of components coaxially mounted thereon, the first group of components including: a first dynamoelectric machine configured to operate at a first revolution per minute (RPM) setting; a first steam turbomachine; a first gas turbomachine; and a reheat combustor; and a second shaft separated from the first shaft, the second shaft having a second group of components coaxially mounted thereon, the second group of components including: a second dynamoelectric machine configured to operate at a second RPM setting above the first RPM setting; a second steam turbomachine; a second gas turbomachine; and a duct fluidly coupled to the second gas turbomachine and the reheat combustor, the duct for providing exhaust from the second gas turbomachine to the reheat combustor.

A third aspect of the invention includes a system having: a first shaft having a first group of components coaxially mounted thereon, the first group of components including: a first steam turbomachine; a first gas turbomachine; and a reheat combustor; a second shaft separated from the first shaft, the second shaft having a second group of components coaxially mounted thereon, the second group of components including: a second steam turbomachine; a second gas turbomachine; and a duct fluidly coupled to the second gas turbomachine and the reheat combustor, the duct for providing exhaust from the second gas turbomachine to the reheat combustor; and a control system operably connected to the first group of components and the second group of components, the control system configured to modify an operating condition of at least one component in the first group of components in response to determining an operating condition of at least one component in the second group of components deviates from a predetermined threshold range.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a system, including a combined-cycle power system according to various embodiments of the invention.

It is noted that the drawings of the invention are not necessarily to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As noted, the subject matter disclosed herein relates to power systems. More particularly, the subject matter relates to combined-cycle power systems.

As described herein, conventional turbines (e.g., GT and/or ST) are commonly configured to operate at a predetermined speed range, but some of the turbine hardware, e.g., including buckets (also referred to as blades) such as last stage buckets (LSBs) may operate more efficiently at different speeds outside of the predetermined speed range. Further, where a combined cycle power system operates on a common shaft (also referred to as a single-shaft configuration), it can be difficult to efficiently employ ancillary components such as combustors to integrate operation of the ST and the GT components.

In contrast to the conventional approaches, various embodiments of the invention include a multi-shaft combined cycle power system which has both a GT component and an ST component on each of the multiple shafts. Each of the shafts can be configured to operate at distinct speeds (non-zero speeds). In various embodiments, each shaft is configured to operate at a distinct speed from the other shaft, where both speeds are multiples of either 3600 RPM (60 Hertz) or 3000 RPM (50 Hertz).

In various particular embodiments, a power system is disclosed. The power system can include a multi-shaft configuration, for example, a two-shaft configuration. Each of the two shafts can include a gas turbine component and a steam turbine component, respectively. As described herein, in various embodiments, each shaft runs at a different speed, enabling the system to run in a combined cycle mode at different outputs. The systems according to embodiments described herein are designed to operate at distinct speeds, including lower speeds such as 1500-1800 revolutions per minute (RPM). Each shaft can be oriented at any suitable angle with respect to the other in order to enable fluid flow between components on the distinct shafts. In some particular cases, as described herein, a first shaft is oriented approximately perpendicularly with a second shaft.

Various particular aspects of the invention include a system having: a first shaft having a first group of components coaxially mounted thereon, the first group of components including: a first steam turbomachine; a first gas turbomachine; and a reheat combustor; a second shaft separated from the first shaft, the second shaft having a second group of components coaxially mounted thereon, the second group of components including: a second steam turbomachine; a compressor; a combustor; a second gas turbomachine; and a duct fluidly coupled to the second gas turbomachine and the reheat combustor, the duct for providing exhaust from the second gas turbomachine to the reheat combustor. In some cases, the system(s) can include a control system operably connected to the first group of components and the second group of components. The control system can be configured (e.g., wired, programmed or otherwise configured) to modify an operating condition of at least one component in the first group of components in response to determining an operating condition of at least one component in the second group of components deviates from a predetermined threshold range.

Other particular aspects of the invention includes a system having: a first shaft having a first group of components coaxially mounted thereon, the first group of components including: a first dynamoelectric machine configured to operate at a first revolution per minute (RPM) setting; a first steam turbomachine; a first gas turbomachine; and a reheat combustor; and a second shaft separated from the first shaft, the second shaft having a second group of components coaxially mounted thereon, the second group of components including: a second dynamoelectric machine configured to operate at a second RPM setting above the first RPM setting; a second steam turbomachine; a compressor; a combustor; a second gas turbomachine; and a duct fluidly coupled to the second gas turbomachine and the reheat combustor, the duct for providing exhaust from the second gas turbomachine to the reheat combustor.

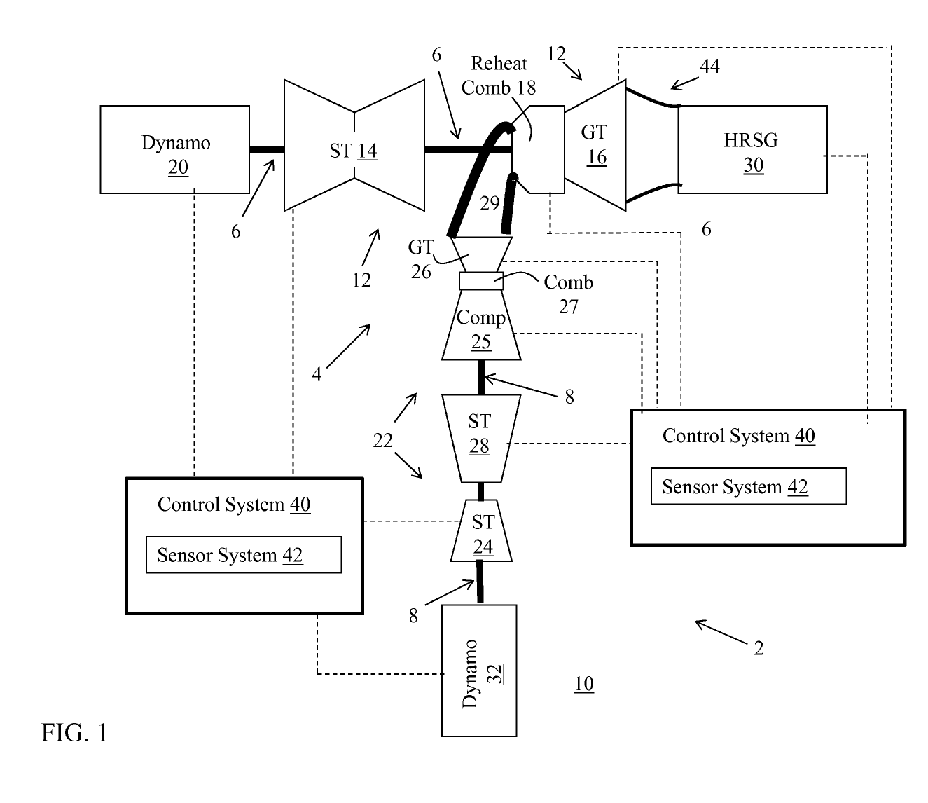

Turning to FIG. 1, a schematic view of a system 2 is shown according to various embodiments of the invention. As shown, the system 2 can include a combined-cycle power system 4 (which includes at least one steam turbomachine and at least one gas turbomachine, which can be used in conjunction to output power). In various embodiments, the combined-cycle power system 4 can include two distinct shafts: a first shaft 6 and a second shaft 8. In some cases, the first shaft 6 and the second shaft 8 are mechanically disconnected (de-coupled) from one another, and in some cases, the first shaft 6 and second shaft 8 are aligned approximately perpendicular with respect to one another in a plane 10). However, it is understood that the first shaft 6 and the second shaft 8 can be aligned at any angle with respect to one another, and the perpendicular configuration shown is not intended to be limiting.

Coaxially mounted on the first shaft 6 is a first group of components 12, including: a first steam turbomachine (ST) 14 (e.g., a steam turbine), a first gas turbomachine (GT) 16 (e.g., a gas turbine), and a reheat combustor 18 (e.g., a conventional combustion reheater for increasing the temperature of an input fluid to provide a hotter output fluid). As noted, each of the first group of components 12 is mounted on the first shaft 6, such that each of the first group of components 12 is configured to rotate approximately in unison with the first shaft 6. In some cases, the first ST 14 can include a low pressure (LP) steam turbine, which can include a dual flow LP steam turbine. In some cases, the reheat combustor 18 is fluidly connected with the first GT 16, e.g., for providing a reheated gas to the first gas GT 16.

In some embodiments, the system 2 (and combined-cycle power system 4) can further include a first dynamoelectric machine 20 (e.g., a first generator) coaxially mounted on the first shaft 6, and configured to rotate with the first ST 14 and the first GT 16. The first dynamoelectric machine 20 can be configured to rotate at a first revolutions-per-minute (RPM) setting. In various particular embodiments, the first RPM setting is approximately 1800 RPM. In other embodiments, the first RPM setting is approximately 1500 RPM.

As shown, the system 2 (and combined cycle system 4) can also include a second group of components 22 coaxially mounted on the second shaft 8, where those components 22 are configured to rotate in unison with the second shaft 8. In some cases, the second group of components 22 can include: a second steam turbomachine (ST) 24, e.g., a steam turbine, a compressor (Comp) 25 coaxially mounted on second shaft 8, a combustor (Comb) 27 coaxially mounted on second shaft 8 and fluidly coupled with the compressor, a second gas turbomachine (GT) 26 fluidly coupled with the combustor 27, and a duct 29 fluidly coupled to the second GT 26 and the reheat combustor 18. The duct 29 can provide exhaust gas from the second GT 26 to the reheat combustor 18, and the reheat combustor 18 can use the heat from that exhaust gas to increase the temperature of an inlet fluid (e.g., gas) to provide a working gas fluid to the first GT 16. As will be described herein, because the first GT 16 operates at a lower RPM setting than the second GT 26, the exhaust from the second GT 26 has sufficient thermal energy to work as an input to the reheat combustor 18 for providing gas to the first GT 16.

In various embodiments, the system 2 (and combined cycle system 4) can also include a third steam turbomachine (ST) 28, e.g., a steam turbine, coaxially mounted on the second shaft 8. According to various embodiments of the invention, the second steam turbomachine 24 includes a high pressure (HP) steam turbomachine, and the third ST 28 includes an intermediate pressure (IP) steam turbomachine.

Even further, in some cases, the system 2 (and combined cycle system 4) can include a heat recovery steam generator (HRSG) 30. The HRSG 30, as with conventional HRSG devices, can be configured to receive exhaust gas from a gas turbomachine, along with a fluid such as water and steam (e.g., from a water or steam source) and use the thermal energy of the gas to heat the fluid and produce steam for a steam turbomachine. In the configuration shown in system 2, the HRSG 30 is configured to receive exhaust gas from the first GT 16, and in some cases, use that exhaust gas to aid in producing steam for at least one of the first ST 14, second ST 24 and/or third ST 28.

As described herein, in various embodiments, the first GT 16 is configured to operate at a lower speed than the second GT 26, and in some cases, is configured to operate at approximately half the speed of the second GT 26.

In some embodiments, the system 2 (and combined-cycle power system 4) can further include a second dynamoelectric machine 32 (e.g., a second generator) coaxially mounted on the second shaft 8, and configured to rotate with the second ST 24, third ST 28 (in some embodiments), and the second GT 26. The second dynamoelectric machine 32 can be configured to rotate at a second revolutions-per-minute (RPM) setting. In various particular embodiments, the second RPM setting is approximately 3600 RPM. In some other embodiments (e.g., where the first RPM setting is approximately 1500 RPM), the second RPM setting is approximately 3000 RPM.

In various embodiments, the second RPM setting is approximately twice the value of the first RPM setting, such that the first dynamoelectric machine 20 and the second dynamoelectric machine 32 are configured to run at approximately at 1:2 RPM ratio during operation of the system 2.

The system 2 can also include a control system 40 (shown bifurcated for clarity of illustration), which can be operably connected (e.g., via wireless and/or hard-wired means, indicated by dashed lines) to any of the first group of components 12, the second group of components 22, the HRSG 30, the first dynamoelectric machine 20 and/or the second dynamoelectric machine 32. The control system 40 can include any conventional turbomachine and/or dynamoelectric machine hardware and/or software, including, e.g., a memory, one or more processors, a user interface, one or more communications buses, (wireless) transmitter(s), (wireless) receiver(s), etc. The control system 40 can be programmed or otherwise configured to monitor operating conditions of the component(s) to which it is connected. The control system 40 can include a sensor system 42, which may include one or more sensors (not shown) for measuring one or more operating conditions of the components noted herein. In some cases, the control system 40 can monitor operating conditions of a turbomachine such as fluid temperature, leakage, flow rate, rotating speed, output, etc. In some cases, the control system 40 can monitor operating conditions of a dynamoelectric machine such as rotating speed, output, temperature, etc.

In particular embodiments, the control system 40 is operably connected to the first group of components 12 and the second group of components 22, and the control system 40 is configured to modify an operating condition of at least one component in the first group of components 12 in response to determining an operating condition of at least one component in the second group of components 22 deviates from a predetermined threshold range. That is, the control system 40 can be configured to provide instructions to modify an operating condition (e.g., an operating speed, gas/steam flow rate, etc.) of a component on the first shaft 6 in response to determining that an operating condition (e.g., operating speed, gas/steam flow rate, etc.) of a component on the second shaft 8 deviates from a predetermined threshold range. The predetermined threshold range can include a range of operating conditions such as an upper and lower operating speed, gas/steam flow rate, output, etc. In some particular cases, where the control system 40 determines that the component on the second shaft 8 deviates from the threshold range (e.g., drops below a lower threshold in the range), the control system 40 may send instructions to the duct 27 to open and allow gas from the second GT 26 to enter the reheat combustor 18 and provide gas fluid to the first GT 16. In some cases, the gas exhausted from the first GT 16 can be provided to the HRSG 30 (e.g., via a conduit 44) for generating steam to feed to the first ST 14, second ST 24 and/or the third ST 28.

In various embodiments of the invention, the system 2 is configured to engage the components on the first shaft 6 in response to determining that components on the second shaft 8 are operating below a predetermined threshold range. In some cases, the system 2 is designed to operate using components on both shafts (first shaft 6 and second shaft 8), allowing for different hardware in components on the first shaft 6 as opposed to the second shaft 8. More specifically, the arrangement of components in the system 2 allows for use of longer than conventional last-stage-buckets (LSBs) in the first ST 14 and/or the first GT 16, because these LSBs will operate within a turbine running at a lower (e.g., half) speed. Additionally, use of the two-shaft system 2 allows for implementation of the reheat combustor 18, which can make the system 2 more efficient when compared to conventional combined cycle systems.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It is further understood that the terms “front” and “back” are not intended to be limiting and are intended to be interchangeable where appropriate.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

We claim:

1. A combined-cycle power system comprising:
a first shaft having a first group of components coaxially mounted thereon, the first group of components including:
a first steam turbomachine;
a first gas turbomachine; and
a reheat combustor; and
a second shaft separated from the first shaft, the second shaft having a second group of components coaxially mounted thereon, the second group of components including:
a second steam turbomachine;
a second gas turbomachine; and
a duct fluidly coupled to the second gas turbomachine and the reheat combustor, the duct for providing exhaust from the second gas turbomachine to the reheat combustor.

2. The combined-cycle power system of claim 1, further comprising a third steam turbomachine coaxially mounted on the second shaft.

3. The combined-cycle power system of claim 2, wherein the second steam turbomachine includes an intermediate pressure steam turbomachine, and the third steam turbomachine includes a high pressure steam turbomachine.

4. The combined-cycle power system of claim 1, further comprising a heat recovery steam generator (HRSG) coupled to the first gas turbomachine, wherein the HRSG is configured to receive exhaust gas from the first gas turbomachine.

5. The combined-cycle power system of claim 1, further comprising:
a combustor fluidly coupled with the second gas turbomachine; and
a compressor fluidly coupled with the combustor.

6. The combined-cycle power system of claim 1, further comprising a first dynamoelectric machine coupled with the first shaft.

7. The combined-cycle power system of claim 6, further comprising a second dynamoelectric machine coupled with the second shaft.

8. The combined-cycle power system of claim 7, wherein the first dynamoelectric machine is configured to operate at a first revolution per minute (RPM) setting, and the second dynamoelectric machine is configured to operate at a second RPM setting distinct from the first RPM setting.

9. The combined-cycle power system of claim 8, wherein the second RPM setting is approximately two times as fast as the first RPM setting.

10. The combined-cycle power system of claim 9, wherein the first RPM setting is approximately 1800 RPM and the second RPM setting is approximately 3600 RPM.

11. The combined-cycle power system of claim 1, wherein the first steam turbomachine includes a low pressure (LP) steam turbomachine (ST).

12. The combined-cycle power system of claim 11, wherein the low pressure (LP) steam turbomachine includes a double-flow steam turbomachine.

13. The combined-cycle power system of claim 1, wherein the first gas turbomachine is configured to operate at a lower speed than the second gas turbomachine.

14. A system comprising:
a first shaft having a first group of components coaxially mounted thereon, the first group of components including:
a first dynamoelectric machine configured to operate at a first revolution per minute (RPM) setting;
a first steam turbomachine;
a first gas turbomachine; and
a reheat combustor; and
a second shaft separated from the first shaft, the second shaft having a second group of components coaxially mounted thereon, the second group of components including:
a second dynamoelectric machine configured to operate at a second RPM setting above the first RPM setting;
a second steam turbomachine;
a second gas turbomachine; and
a duct fluidly coupled to the second gas turbomachine and the reheat combustor, the duct for providing exhaust from the second gas turbomachine to the reheat combustor.

15. The system of claim 14, further comprising a third steam turbomachine coaxially mounted on the second shaft.

16. The system of claim 15, further comprising a heat recovery steam generator (HRSG) fluidly connected with an exhaust of the first gas turbomachine, wherein the HRSG is configured to receive exhaust gas from the first gas turbomachine.

17. The system of claim 14, wherein:
the first RPM setting is approximately 1800 RPM and the second RPM setting is approximately 3600 RPM, or
the first RPM setting is approximately 1500 RPM and the second RPM setting is approximately 3000 RPM.

18. A system comprising:
a first shaft having a first group of components coaxially mounted thereon, the first group of components including:
a first steam turbomachine;
a first gas turbomachine; and
a reheat combustor;
a second shaft separated from the first shaft, the second shaft having a second group of components coaxially mounted thereon, the second group of components including:
a second steam turbomachine;
a second gas turbomachine; and
a duct fluidly coupled to the second gas turbomachine and the reheat combustor, the duct for providing exhaust from the second gas turbomachine to the reheat combustor; and
a control system operably connected to the first group of components and the second group of components, the control system configured to modify an operating condition of at least one component in the first group of components in response to determining an operating condition of at least one component in the second group of components deviates from a predetermined threshold range.

19. The system of claim 18, further comprising:
a first dynamoelectric machine coupled with the first shaft; and
a second dynamoelectric machine coupled with the second shaft.

20. The system of claim 19, wherein the first dynamoelectric machine is configured to operate at a first revolution per minute (RPM) setting, and the second dynamoelectric machine is configured to operate at a second RPM setting distinct from the first RPM setting.
